(19) United States
(12) Patent Application Publication
(10) Pub. No.: US 2017/0097414 A1
(43) Pub. Date: Apr. 6, 2017

(54) APPARATUS AND METHOD FOR DETECTING OBJECT ON ROAD

(71) Applicant: Hyundai Motor Company, Seoul (KR)

(72) Inventors: Byung Yong You, Suwon (KR); Myung Seon Heo, Seoul (KR); Young Chul Oh, Seongnam (KR)

(21) Appl. No.: 15/180,894

(22) Filed: Jun. 13, 2016

(30) Foreign Application Priority Data
Oct. 6, 2015 (KR) 10-2015-0140596

(51) Int. Cl. G01S 13/86; G01S 13/42; G01S 7/04; G01S 13/93

(52) U.S. Cl. CPC G01S 13/865; G01S 13/931; G01S 13/42; G01S 7/04

(57) ABSTRACT

An apparatus and method for detecting an object on a road are capable of enhancing performance of a driving environment recognition system of a vehicle by detecting a size and a position of an object on a road with high accuracy on the basis of radar and lidar data respectively obtained using a radar sensor and a lidar sensor installed in the vehicle.

### CROSS-REFERENCE TO RELATED APPLICATION

This application claims under 35 U.S.C. §119(a) the benefit of Korean Patent Application No. 10-2015-0140596, filed on Oct. 6, 2015 in the Korean Intellectual Property Office, the entire contents of which are incorporated by reference herein.

### BACKGROUND

(a) Technical Field

The present invention relates to an apparatus and method for detecting an object on a mad, and more particularly, to a technique of accurately detecting a position and a size of an object (moving object or fixed object) on the road by combining radio detecting and ranging (RaDAR, referred to herein using the common expression “radar”) data and light detection and ranging (LiDAR, referred to herein using the common expression “lidar”) data.

(b) Description of the Related Art

A technique of enabling a vehicle to recognize a driving environment is essential to ensure safe driving even in a vehicle adopting an advanced driver assistance system (ADAS), an adaptive cruise control (ACC) system, an autonomous emergency braking (AEB) system, and a lane keeping assistance (LKA) system, as well as in an autonomous vehicle.

Such a recognition technique requires collecting accurate and reliable information regarding a driving environment of a vehicle; however, since the recognition technique has been developed on the basis of a single sensor, it has problems such as limitations in a recognition range, measurement error, and misrecognition.

For reference, sensors generally used in vehicles include radar, lidar, and a camera for estimating a position, size, and state of a front or rear object. However, such single sensors have limitations based on the particular technology.

As a solution, a technique of detecting an object around a vehicle by combining sensor data measured by sensors has been developed, but a scheme of combining radar data and lidar data specifically has yet to be proposed.

### SUMMARY

An aspect of the present invention provides an apparatus and method for detecting an object on a mad, capable of enhancing performance of a driving environment recognition system of a vehicle by detecting a size and a position of an object on a road with high accuracy on the basis of radio detecting and ranging (“radar”) data and light detection and ranging (“lidar”) data respectively obtained using a radar sensor and a lidar sensor installed in a vehicle.

Technical subjects of the present invention are not limited to the foregoing technical subjects and any other technical subjects not mentioned will be understood from the following descriptions and become apparent by exemplary embodiments of the present invention. Also, it may be easily understood that the advantages, features and aspects of the present invention may be realized by means and combinations demonstrated in claims.

According to an exemplary embodiment of the present invention, an apparatus for detecting an object on a road includes: a memory configured to store region information having a size corresponding to a distance from a vehicle; a radar configured to detect the object on the road by scanning a front region of the vehicle; a lidar configured to detect the object on the road by scanning the front region of the vehicle; and a controller configured to detect the region information having the size corresponding to the distance to the object detected by the radar from the memory, to compensate for the detection information regarding the object detected by the lidar in consideration of a detection error range of the lidar, and to subsequently combine the compensated detection information and the region information to detect the object.

According to another exemplary embodiment of the present invention, a method for detecting an object on a road includes: storing, by a memory, region information having a size corresponding to a distance from a vehicle; detecting, by a radar, the object on the road by scanning a front region of the vehicle; detecting, by a lidar, the object on the road by scanning the front region of the vehicle; detecting, by a controller, the region information having the size corresponding to the distance to the object detected by the radar from the memory; compensating, by the controller, for detection information regarding the object detected by the lidar in consideration of a detection error range of the lidar, and combining, by the controller, the compensated detection information and the region information to detect the object.

A non-transitory computer readable medium containing program instructions executed by a processor can include: program instructions that store region information having a size corresponding to a distance from a vehicle; program instructions that detect, by a radar, an object on a road by scanning a front region of the vehicle; program instructions that detect, by a lidar, the object on the road by scanning the front region of the vehicle; program instructions that detect the region information having the size corresponding to the distance to the object detected by the radar from the memory; program instructions that compensate for detection information regarding the object detected by the lidar in consideration of a detection error range of the lidar and program instructions that combine the compensated detection information and the region information to detect de object.

### BRIEF DESCRIPTION OF THE DRAWINGS

The above and other objects, features and advantages of the present invention will be more apparent from the following detailed description taken in conjunction with the accompanying drawings.

FIG. 1 is a block diagram of an apparatus for detecting an object on a road according to an exemplary embodiment of the present invention.

FIG. 2 is a detailed block diagram of a controller according to an exemplary embodiment of the present invention;

FIG. 3A is a view illustrating an actual road environment used in an exemplary embodiment of the present invention.

FIG. 3B is a view illustrating data detected by radar regarding the actual road environment of FIG. 3A.

FIG. 3C is a view illustrating data detected by lidar regarding the actual road environment of FIG. 3A.

FIGS. 4A to 4D are views illustrating a process of detecting an object on a road according to an exemplary embodiment of the present invention.

FIG. 5 is a flow chart illustrating a method for detecting an object on a road according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The aforementioned objects, features and advantages of the present invention will become more apparent through the following detailed description with respect to the accompanying drawings, and accordingly, a technical concept of the present invention may be easily practiced by those skilled in the art to which the present invention pertains. In describing the exemplary embodiments of the present invention, when it is determined that a detailed description of known components or functions associated with the present invention unnecessarily obscures the gist of the present invention, the detailed description thereof will be omitted. Hereinafter, the exemplary embodiments of the present invention will be described in detail with reference to the accompanying drawings.

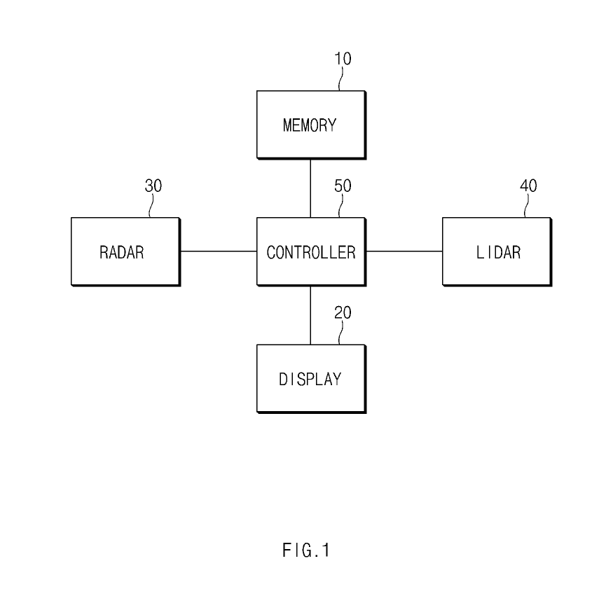

FIG. 1 is a block diagram of an apparatus for detecting an object on a road according to an exemplary embodiment of the present invention.

As illustrated in FIG. 1, an apparatus for detecting an object on a road according to an exemplary embodiment of the present invention includes a memory 10, a display 20, a radio detecting and ranging (RaDAR) (or “radar”) 30, a light detection and ranging (LiDAR) (or “lidar”) 40, and a controller 50.

The memory 10 stores region information having a predetermined size corresponding to a distance from a vehicle. Here, the region information represents an error limit region regarding a size of an object set by distance with respect to the object detected by the radar 30. That is, when the radar 30 detects a vehicle positioned at a distance of 10 meters on a mad, a size of the detected vehicle does not exceed an error limit region corresponding to the distance of 10 meters. Here, the distance to the object includes a distance in a longitudinal direction and a distance in a transverse direction.

The display 20 displays various types of information on a screen under the control of the controller 50.

The radar 30 detects an object on a road by scanning a front region of a vehicle.

For reference, the radar 30 transmits electromagnetic waves of microwaves (having a wavelength ranging from about 10 cm to 100 cm) to the object to receive electromagnetic waves reflected from the object to detect a distance to the object and a direction and an altitude of the object.

The lidar 40 is a sort of radar developed using a laser light having properties close to a radio wave. The lidar 40 detects an object on a mad by scanning a font region of a vehicle.

Table a below illustrates characteristics of the radar 30 and the lidar 40.

TABLE 1

| | Radar | Lidar |
|---|---|---|
| source | Radio wave | Laser beam |
| output | Measured objects in | Measurement point in |
| | units of tens | units of thousands |
| | | according to resolu- |
| | | tion and layer |
| Performance | It can measure even | It recognizes only |
| according | invisible object | object viewed in |
| to measurement | The same performance | straight line |
| environment | even in deteriorating | Performance is |
| | weather | degraded in |
| | | deteriorating |
| | | weather |
| Recognition | It can determine only | It can recognize |
| of outer | presence and absence | specific shape of |
| shape of object | of object | object |
| Recognition | It can recognize number | It cannot recognize |
| of number of | of objects | number of objects |
| objects | | |
| Classification | Possible to be | Impossible to be |
| of moving/fixed | classified | classified |
| object | | |
| Object tracking | Possible to track | Impossible to track |
| Error in | Error in traverse | There is no error |
| longitudinal/ | direction is | according to distance, |
| traverse | increased according | but a measurement |
| direction | to distance | point is reduced |
| | | according to distance |

The controller 50 controls the various components to allow the components to function normally.

In particular, the controller 50 detects a size and a position of an object on a road with high accuracy in consideration of the advantages of the radar 30 and the advantages of the lidar 40 as described above.

That is, the controller 50 detects region information having a predetermined size corresponding to a distance to the object detected by the radar 30 from the memory 10, compensates for the detection information regarding the object detected by the radar 30 in consideration of a detection error range of the lidar 40, and combines the compensated detection information and the region information to detect a size and a position of the object. Here, the controller 50 gives a predetermined margin to the detection information regarding the object detected by the lidar 40. That is, the controller 50 sets the size indicated by the detection information to the maximum level in consideration of the detection error range of the lidar 40.

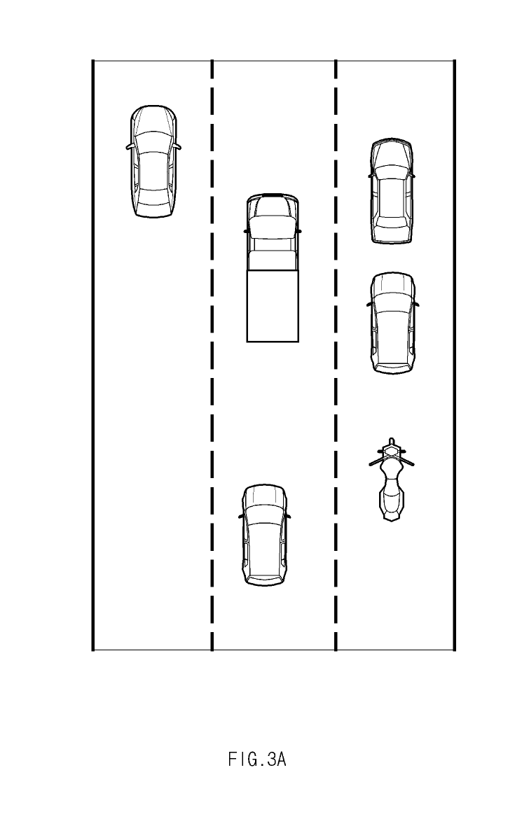

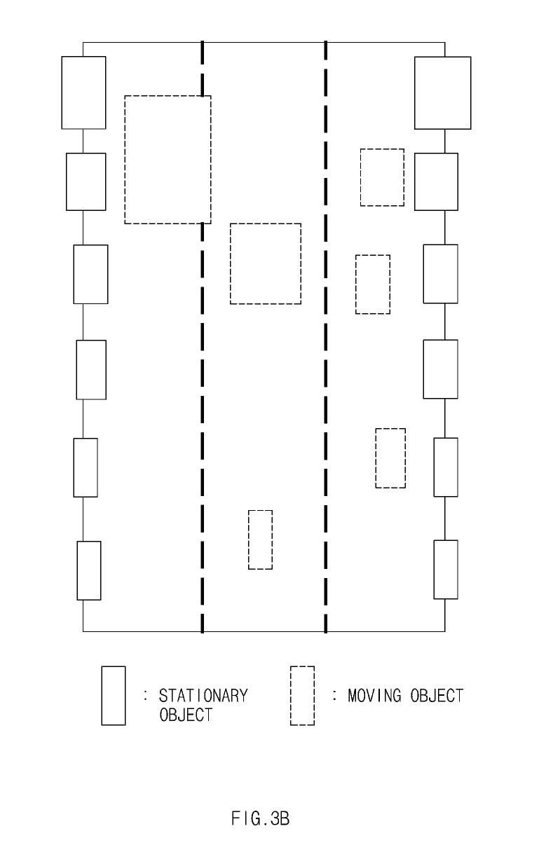

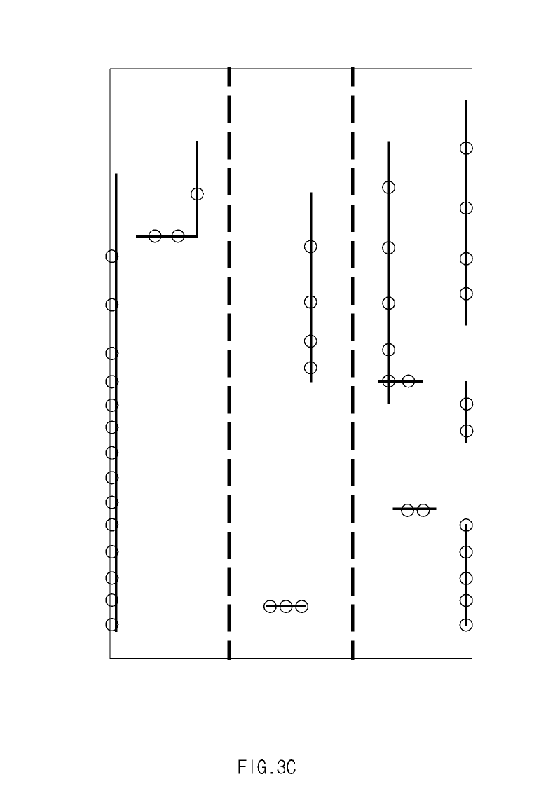

For example, in a road environment as illustrated in FIG. 3A, the controller 50 detects the region information having a predetermined size corresponding to the distance to the object detected by the radar 30 from the memory 10 and displays the detection result on a screen as illustrated in FIG. 3B. Also, the controller 50 compensates for the detection information regarding the object detected by the lidar 40 in consideration of the detection error range of the lidar 40 and subsequently displays the result on the screen as illustrated in FIG. 3C. In FIG. 3B, the controller 50 displays the region information of the moving object by the dotted lines.

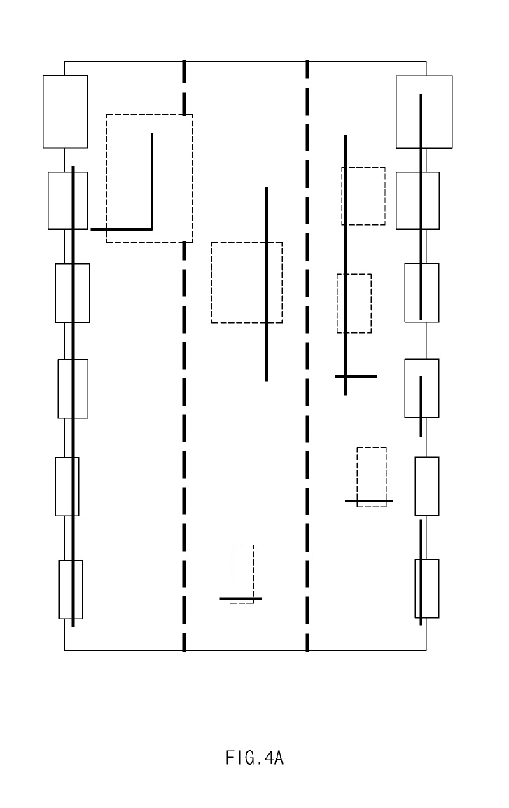

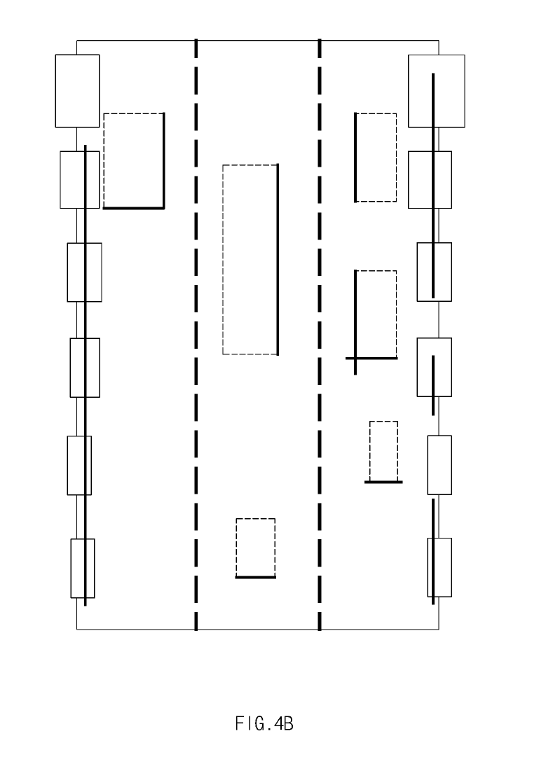

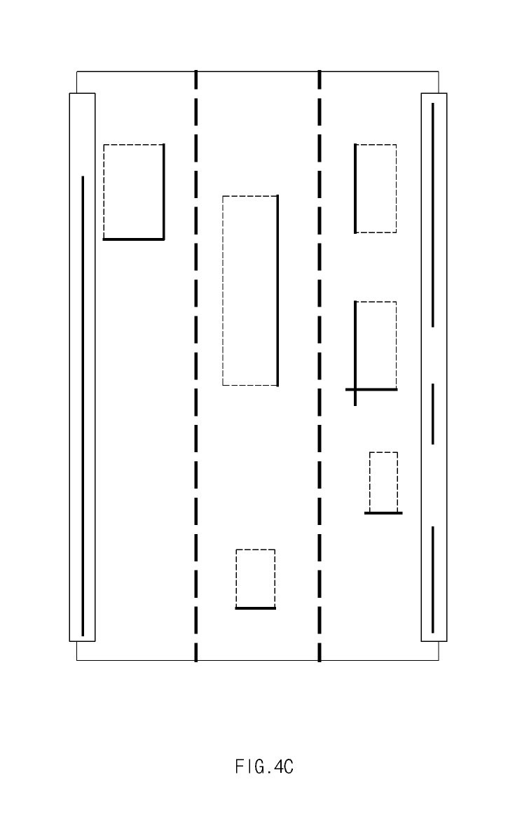

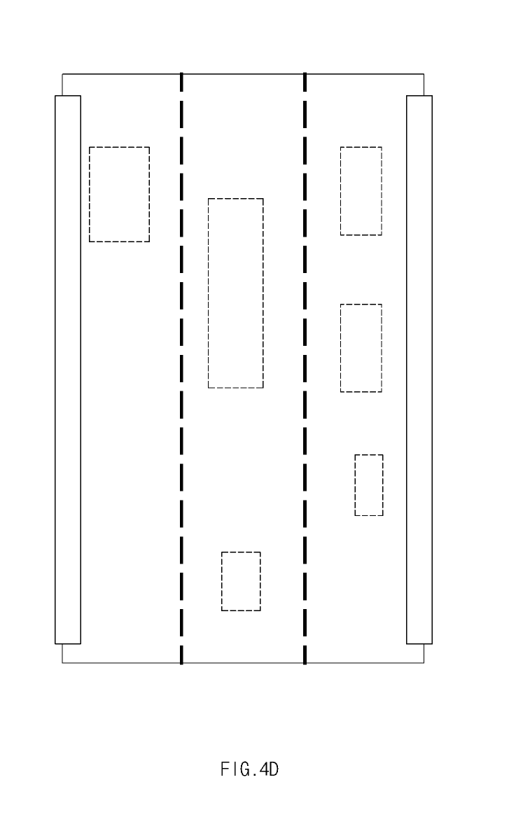

Hereinafter, a process of combining the compensated detection information and the region information by the controller 50 will be described in detail with reference to FIGS. 4A to 4D.

First, the controller 50 matches and integrates the region information (quadrangular blocks) as illustrated in FIG. 3B and the detection error range-compensated detection information of the lidar 40 as illustrated in FIG. 3C to generate integration information. A result thereof is illustrated in FIG. 4A.

Thereafter, in the integration information illustrated in FIG. 4A, the controller 50 corrects the number of moving objects with respect to the region information and corrects a size and a position of each of the moving objects with respect to the compensated detection information. The correction result is illustrated in FIG. 4B.

Thereafter, in the result of correction as illustrated in FIG. 4B, on the basis of the region information, the controller 50 clusters fixed objects positioned within a predetermined distance to one object, corrects a width of a result of clustering (hereinafter, referred to as “cluster”) to a preset size and corrects a length of the cluster with respect to the region information. The clustering result is illustrated in FIG. 4C.

Thereafter, in the result of correction as illustrated in FIG. 4C, the controller 50 displays moving objects by the quadrangular dotted lines and removes the compensated detection information from an interior of the cluster to generate a final result as illustrated in FIG. 4D.

When the result detected by the apparatus for detecting an object on a road according to an exemplary embodiment illustrated in FIG. 4D and the actual road environment illustrated in FIG. 3A are compared, it can be seen that sizes and positions of the objects are very accurate.

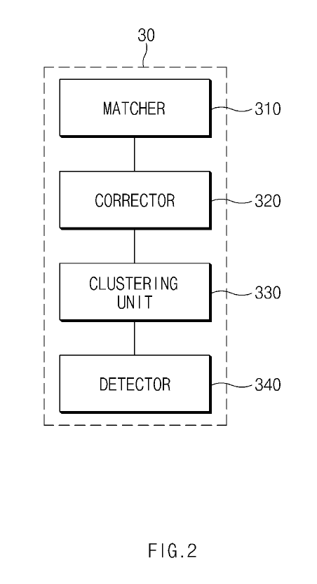

Hereinafter, a specific configuration of the controller 50 will be described with reference to FIG. 2.

FIG. 2 is a detailed block diagram of a controller according to an exemplary embodiment of the present invention.

As illustrated in FIG. 2, the controller 50 according to an exemplary embodiment of the present invention includes a matcher 310, a corrector 320, a clustering unit 330, and a detector 340.

Referring to the elements, first, the matcher 310 matches the region information as illustrated in FIG. 3B and the detection error range-compensated detection information of the lidar 40 as illustrated in FIG. 3C. A result thereof is illustrated in FIG. 4A.

Next, the corrector 320 corrects the number of moving objects in the integration information as illustrated in FIG. 4A with respect to the region information and corrects a size and a position of each of the moving objects with respect to the compensated detection information. A result thereof is illustrated in FIG. 4B.

Thereafter, the clustering unit 330 clusters fixed objects positioned within a predetermined distance into one object in the correction result as illustrated in FIG. 4B, and here, the clustering unit 330 corrects a width of the cluster to a preset size and corrects a length of the cluster with respect to the region information. The cluster is as illustrated in FIG. 4C.

Thereafter, the detector 340 detects sizes of the objects from the correction result as illustrated in FIG. 4C.

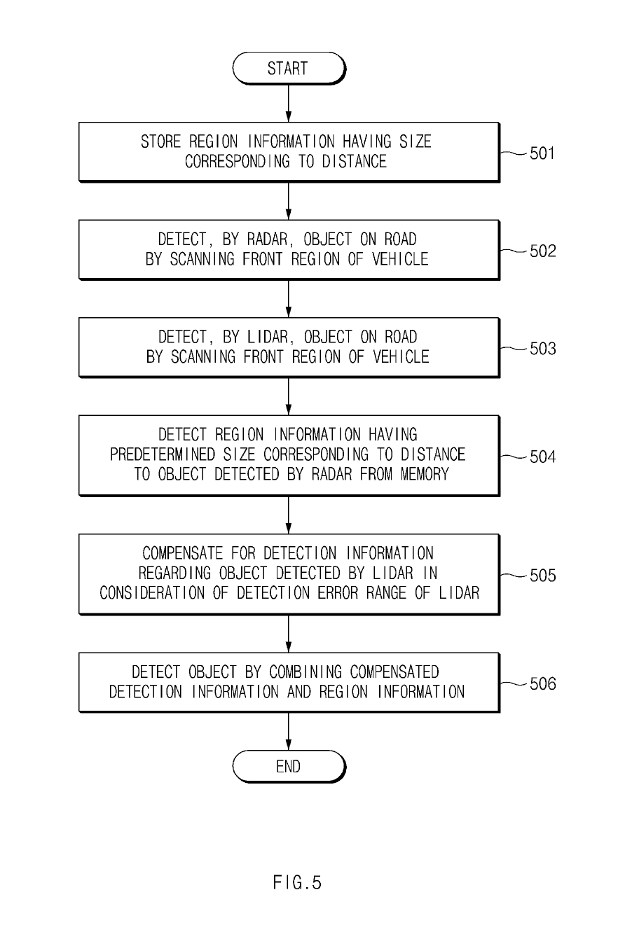

FIG. 5 is a flow chart illustrating a method for detecting an object on a road according to an exemplary embodiment of the present invention.

First, the memory 10 stores region information having a size corresponding to a distance in operation 501.

Next, the radar 30 detects an object on a road by scanning a front region of a vehicle in operation 502.

Thereafter, the lidar 40 detects an object on a road by scanning a front region of the vehicle in operation 503.

Thereafter, the controller 50 detects region information having a predetermined size corresponding to a distance to the object detected by the radar 30 from the memory in operation 504.

Thereafter, the controller 50 compensates for the detection information regarding the object detected by the lidar 40 in consideration of a detection error range of the lidar 40 in operation 505.

Thereafter, the controller 50 combines the compensated detection information and the region information to detect the object in operation 506.

Through this process, the object on the driving road may be detected with high accuracy.

As described above, according to the exemplary embodiments of the present invention, a size and a position of an object on a driving road may be detected with high accuracy on the basis of radar data and lidar data respectively obtained using a radar sensor and a lidar sensor installed in a vehicle.

Also, according to the exemplary embodiments of the present invention, since a size and a position of an object on a driving road may be detected with high accuracy on the basis of radar data and lidar data respectively obtained using a radar sensor and a lidar sensor installed in a vehicle, performance of a system for recognizing a driving environment of a vehicle may be enhanced.

In addition, according to the exemplary embodiments of the present invention, a continuous fixed object such as a guard rail may be integrally detected.

The method according to exemplary embodiments of the present invention described above may also be created as a computer program, and codes and code segments configuring the program may be easily inferred by programmers in the art. In addition, the created program may be stored in a computer-readable recording medium (an information storage medium) and read and executed by a computer to implement the method of the present invention. The recording medium includes any type of recording medium that can be read by a computer.

Hereinabove, although the present invention has been described with reference to exemplary embodiments and the accompanying drawings, the present invention is not limited thereto, but may be variously modified and altered by those skilled in the art to which the present invention pertains without departing from the spirit and scope of the present invention claimed in the following claims.

What is claimed is:

1. An apparatus for detecting an object on a road, the apparatus comprising
a memory configured to store region information having a size corresponding to a distance from a vehicle;
a radar configured to detect the object on the mad by scanning a front region of the vehicle;
a lidar configured to detect the object on the mad by scanning the front region of the vehicle; and
a controller configured to detect the region information having the size corresponding to the distance to the object detected by the radar from the memory, to compensate for the detection information regarding the object detected by the lidar in consideration of a detection error range of the lidar, and to subsequently combine the compensated detection information and the region information to detect the object.

2. The apparatus according to claim 1, wherein when the controller combines the compensated detection information and the region information, the controller corrects a number of the object with respect to the region information.

3. The apparatus according to claim 1, wherein when the controller combines the compensated detection information and the region information, the controller corrects the size and a position of the object with respect to the compensated detection information.

4. A method for detecting an object on a mad, the method comprising the steps of:
storing, by a memory, region information having a size corresponding to a distance from a vehicle;
detecting, by a radar, the object on the mad by scanning a front region of the vehicle;
detecting, by a lidar, the object on the mad by scanning the front region of the vehicle;
detecting, by a controller, the region information having the size corresponding to the distance to the object detected by the radar from the memory;
compensating, by the controller, for detection information regarding the object detected by the lidar in consideration of a detection error range of the lidar, and
combining, by the contoller, the compensated detection information and the region information to detect the object.

5. The method according to claim 4, wherein when the compensated detection information and the region information are combined, a number of the object is corrected with respect to the region information.

6. The method according to claim 4, wherein when the compensated detection information and the region information are combined, the size and a position of the object are corrected with respect to the compensated detection information.

7. A non-transitory computer readable medium containing program instructions executed by a processor, the computer readable medium comprising
program instructions that store region information having a size corresponding to a distance from a vehicle;
program instructions that detect, by a radar, an object on a road by scanning a front region of the vehicle;
program instructions that detect, by a lidar, the object on the road by scanning the front region of the vehicle;
program instructions that detect the region information having the size corresponding to the distance to the object detected by the radar from the memory;
program instructions that compensate for detection information regarding the object detected by the lidar in consideration of a detection error range of the lidar, and
program instructions that combine the compensated detection information and the region information to detect the object.
